(19) United States
(12) Patent Application Publication
(10) Pub. No.: US 2017/0366514 A1
(43) Pub. Date: Dec. 21, 2017

(54) CODE OBFUSCATION AND ASSOCIATED OBJECTS

(71) Applicant: Lior Malka, San Jose, CA (US)

(72) Inventor: Lior Malka, San Jose, CA (US)

(21) Appl. No.: 15/185,532

(22) Filed: Jun. 17, 2016

(51) Int. Cl. H04L 29/06; H04L 9/32

(52) U.S. Cl. CPC H04L 63/0428; H04L 9/3247; H04L 2209/72; H04L 2209/16

(57) ABSTRACT

Obfuscation transforms original code into an obfuscated code that is less intelligible, but behaves like the original. In one embodiment, a data sequence describing an obfuscator is processed by a reader who outputs an obfuscator. The data sequence may be stored or transmitted and the obfuscator may be used for code obfuscation. In one embodiment, additional readers are used to create objects associated with the obfuscated code. In one embodiment, a generator produces encrypted files and obfuscated code that can decrypt and encrypt the files.

### BACKGROUND

Obfuscation transforms original code into an obfuscated code for mitigating reverse engineering, modification, and other attacks on the code. The obfuscated code is less intelligible, but behaves like the original. Various obfuscation techniques have been proposed. A disadvantage of existing obfuscators is that they are not serializable. Serialization involves the formatting of data so that it can be transmitted or stored. Another disadvantage of existing obfuscators is that they do not provide objects associated with the obfuscated code, and therefore do not take full advantage of the benefits of obfuscation.

### SUMMARY

Embodiments are provided for code obfuscation. In one embodiment, data is written into a sequence, which may be stored or transmitted over a network, and a reader extracts elements from the sequence to initialize a code obfuscator. The obfuscator may be used for code obfuscation. In one embodiment, an object reader is used to read an object from the sequence, and the object may be associated with the obfuscator. In one embodiment, input is given to a generator that outputs a sequence. An encryption initialized with a key is read from the sequence. An obfuscator initialized to produce code for decrypting cipher texts created with the encryption using the key is also read from the sequence. Data included in the input is encrypted using the encryption and stored in an encrypted file.

### DRAWINGS

The following figures illustrate the embodiments by way of example. They do not limit their scope.

FIG. 1 shows a flow diagram of a method of initializing an obfuscator from serialized data, in accordance with one embodiment.

FIG. 2 shows a flow diagram of a method of initializing an obfuscator and associated objects from serialized data, in accordance with one embodiment.

FIG. 3 shows a flow diagram of a method of producing random obfuscated code with corresponding random encryption, in accordance with one embodiment.

### DETAILED DESCRIPTION

This section includes detailed examples, particular embodiments, and specific terminology. These are not meant to limit the scope. They are intended to provide clear and through understanding, cover alternatives, modifications, and equivalents.

Obfuscation is a transformation from code in one domain to another code in the same or another domain. The transformed code is intended to be less intelligible than the original code, while preserving the original code behavior. The obfuscation may or may not require the original code in order to produce transformed code. In cryptography, encryption provides data confidentiality and signatures provide data integrity. Signcryption provides both. An object implemented using software or hardware can represent any logic, including obfuscation, encryption, signatures, and signcryption. Any object can be serialized.

Serialization involves the formatting of data so that it can be transmitted or stored. The logic writing the data is called a writer and the logic reading the data is called a reader. The serialized data is called a sequence. A sequence may have a physical representation, such as a memory, a file, a network connection, and so on. The writer or the reader can be internal or external to the logic of the serialized object. The writer and the reader may be in physically different locations. The data may be prepended with a type. The type may be used to select or verify a reader. More than one reader may exist for a given type, and readers, even if referring to the same type, can output objects of any kind. Writers and readers can be recursive. For example, if object A contains object B, then the output of a writer for A may include the output of a writer for B, and a reader for A may use a reader for B. An object can represent anything, such as an integer, an obfuscator, an encryption scheme, and so on.

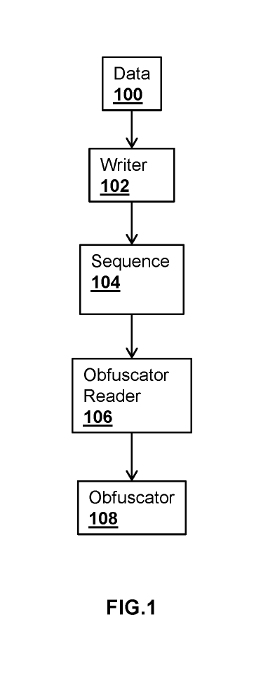

FIG. 1 shows a flow diagram of a method of initializing an obfuscator from serialized data, in accordance with one embodiment. Input data 100 is provided to a writer 102 of a given type. The writer outputs a sequence 104 containing the type followed by the data. For example, the type may be AES, representing the encryption algorithm AES (Advanced Encryption Standard), and the data may be an array of bytes representing a key. An obfuscator reader 106 for the type reads the data and outputs an obfuscator 108 initialized with the data. For example, an obfuscator reader for AES may read an array of bytes representing a key, and output an obfuscator that has been initialized to produce obfuscated code for decrypting cipher texts created with AES encryption using the key. Any obfuscator reader 106 for the type can be used. For example, the reader may output an obfuscator that has been initialized to produce obfuscated code for encrypting plaintexts with AES encryption using the key.

The input data may include elements of different types and may be further processed by the writer. For example, if the data includes an encryption algorithm and a byte array representing a key for the encryption algorithm, then the writer may use the encryption algorithm to determine the length of the key, and the length may be written into the sequence along with the key.

The writer and the obfuscator reader may be operated on physically different devices, by different entities, and at different times.

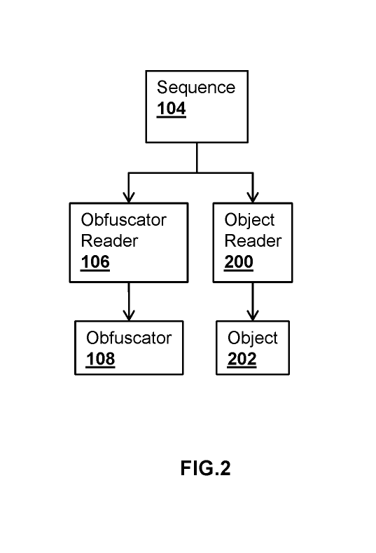

FIG. 2 shows a flow diagram of a method of initializing an obfuscator and associated objects from serialized data, in accordance with one embodiment. A sequence 104 representing data of a given type is provided as input to an obfuscator reader 106 and an object reader 200. The object reader can return an object of any kind. The obfuscator reader reads the data from the sequence, initializes an obfuscator 108, and outputs the obfuscator. The object reader reads the data from the sequence, initializes an object 202, and outputs the object.

To illustrate, suppose that the sequence contains a type and data, the type being AES and the data being an array of bytes representing a key, and suppose that the obfuscator reader outputs an obfuscator that has been initialized to produce obfuscated code for decrypting cipher texts created with AES encryption using the key. Then, the object reader may output an object initialized to encrypt plaintexts with AES encryption using the key.

The sequence may contain elements not used by the object reader or the obfuscator reader or both. Also, the readers can be invoked in any order. If a reader modifies the sequence and such changes are not desirable, then a copy of the original sequence can be used to restore the sequence. Also, a plurality of object readers may be used, and a plurality of objects may be outputted

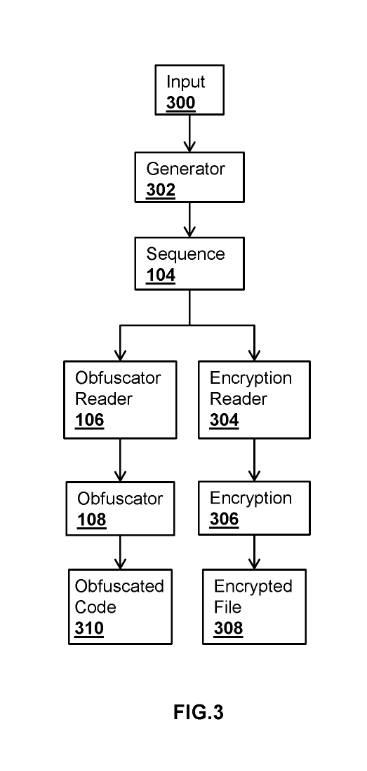

FIG. 3 shows a flow diagram of a method of producing random obfuscated code with corresponding random encryption, in accordance with one embodiment. Input 300 is provided to a generator 302 who generates a sequence 104 that is read by an encryption reader 304. The encryption reader outputs an encryption 306. An encrypted file 308 is produced using the encryption and data contained in the input. An obfuscator reader 106 also reads the sequence and outputs an obfuscator 108 initialized to produce obfuscated code 310 for decrypting cipher texts created with the encryption. The obfuscator outputs the obfuscated code.

The encryption reader can be replaced with any reader for any object suitable for the application of the method, such as a signature or a signcryption, or any other algorithm. The generator may use random values and may be invoked repeatedly. Obfuscated code may require compilation, which may be performed locally or at a different device. Executable obfuscated code and encrypted files may be executed or stored. Alternatively, they can be requested and transmitted over a network.

The specific embodiments and specific terminology used above should not be construed as limiting the scope of the embodiments. These details have been presented for purposes of illustration and are not intended to be exhaustive. Many modifications and uses are possible. The scope of the embodiments is defined by the Claims appended hereto and their equivalents.

What is claimed is:

1. A method of initializing an obfuscator from serialized data, the method comprising:
receiving input containing data; and
writing the input into a sequence; and
reading elements from the sequence; and
using the elements to initialize an obfuscator;
and outputting the obfuscator.

2. The method of claim 1, wherein the sequence is a memory or a file or a network connection.

3. The method of claim 1, wherein the writing is performed on a first device and the reading is performed on a second device.

4. The method of claim 1, further comprising outputting obfuscated code using the obfuscator.

5. A method of initializing an obfuscator and an associated object from serialized data, the method comprising:
receiving a sequence as input; and
reading a first set of elements from the sequence, and;
initializing an obfuscator with the first set of elements; and
reading a second set of elements from the sequence, and;
initializing an object with the second set of elements; and
outputting the obfuscator and the object.

6. The method of claim 5, further comprising restoring the sequence to its original state before reading a the second set of elements.

7. The method of claim 5, wherein a plurality of object readers are used.

8. The method of claim 5, further comprising outputting obfuscated code using the obfuscator.

9. A method of producing random obfuscated code with corresponding random encryption, the method comprising:
receiving input; and
generating a sequence from the input; and
reading elements from the sequence to initialize an encryption; and
outputting an encrypted file using the encryption and data included in the input; and
reading elements from the sequence to initialize an obfuscator that produces obfuscated code for decrypting cipher texts created with the encryption; and
outputting obfuscated code using the obfuscator.

10. The method of claim 9, wherein the encryption is a signature or a signcryption.

11. The method of claim 9, wherein the obfuscator is further adapted to encrypt plaintext with the encryption.

12. The method of claim 9, wherein the obfuscated code is adapted to invoke an application with initialized encryption and decryption.

13. The method of claim 9, further comprising compiling of the obfuscated code.

14. The method of claim 9, wherein the encrypted file contains a second sequence representing a second encryption.

15. The method of claim 9, further comprising sending to recipients over a network the obfuscated code and the encrypted file.

16. The method of claim 9, wherein the data contained in the input is stored in a database.

17. The method of claim 9, wherein the data contained in the input is used for authentication.
